(19) United States
(12) Patent Application Publication
(10) Pub. No.: US 2017/0160301 A1
(43) Pub. Date: Jun. 8, 2017

(54) SPEED AND ANGLE MONITOR FOR ROTATING MACHINERY

(71) Applicant: Schweitzer Engineering Laboratories, Inc., Pullman, WA (US)

(72) Inventor: Marcos A. Donolo, Pullman, WA (US)

(21) Appl. No.: 14/962,155

(22) Filed: Dec. 8, 2015

(51) Int. Cl. G01P 3/44; G01P 15/08

(52) U.S. Cl. CPC G01P 3/44; G01P 15/0888

(57) ABSTRACT

Disclosed herein is a shaft-mounted sensor for determining a rotational component of a rotating shaft. The rotational component may be a rotational speed and an angular position of the rotating shaft. The shaft-mounted sensor may include an accelerometer for measuring a radial acceleration or a tangential acceleration. The rotational component of the rotating shaft may be calculated using one or both of the measured radial acceleration and the tangential acceleration. The shaft-mounted sensor may be in wireless communication with a device for monitoring and protecting rotating machinery.

### RELATED APPLICATION

(None)

### TECHNICAL FIELD

This disclosure relates to the monitoring of rotating machinery. More particularly, this disclosure relates to monitoring a rotational characteristic of a rotating shaft such as rotational speed and angular position using an accelerometer fixed to the rotating shaft.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a block diagram of a system for monitoring a rotational component of a rotating shaft.

FIG. 2 illustrates a block diagram of a system for monitoring a rotational component of a rotating shaft.

FIG. 3 illustrates a cross-sectional view of a rotating shaft and a block diagram of a shaft-mounted sensor for monitoring a rotational component of the rotating shaft.

FIG. 4 illustrates a cross-sectional view of a rotating shaft and a block diagram of a shaft-mounted sensor for monitoring a rotational component of the rotating shaft.

FIG. 5 illustrates a cross-sectional view of a rotating shaft and shaft-mounted sensor at various angular positions of the rotating shaft.

FIG. 6 illustrates plots of the acceleration measured by the shaft-mounted sensor and rotational speed of the rotating shaft.

FIG. 7 illustrates a cross-sectional view of a rotating shaft and shaft-mounted sensor with a dual-axis accelerometer.

FIG. 8 illustrates plots of the acceleration measured by a dual-axis accelerometer and angular position of a rotating shaft.

FIG. 9 illustrates a cross-sectional view of a rotating shaft and a shaft-mounted sensor for monitoring a rotational component of the rotating shaft.

### DETAILED DESCRIPTION

Several different types of rotating machinery are used throughout industry and utilities. For the most part, electric power is generated by rotating a rotor in a stator using a prime mover connected to the rotor by a rotating shaft. Motors use electric power to produce mechanical power delivered by a rotating shaft. It has been estimated that around 45% of the electric power generated globally is used by electric motors. Monitoring and maintenance of electric power generators and electric motors helps to prolong the lifetimes of the equipment and make efficient use of such rotating machinery.

Intelligent electronic devices (“IEDs”) are often used to monitor and control electric power generators and electric motors. IEDs may receive inputs from electric power generators and electric motors such as, for example, signals from the electric power provided to a motor, signals from the electric power produced by a generator, signals from rotors and/or stator of motors or generators, and the like. IEDs may monitor such equipment using the electrical signals. IEDs may also receive inputs from other sensors to monitor such rotating equipment. For example, a speed switch may be used to output a signal that a shaft is rotating. A rotation monitor may be used to output a signal related to a rotational speed and/or position of a rotating shaft. Rotation monitors typically require an encoder mounted to the rotating shaft and a reader (such as an optical reader) configured to read the encoder. Such rotation monitors are bound in accuracy by the granularity of the pattern of the shaft-mounted encoder, and require a specialized reader. Such encoders must be specifically configured for the particular shaft (e.g. size and clearance) to be monitored. Further, the encoder must be carefully aligned with the reader. Rotation of a rotating shaft may also be monitored using a toothed wheel apparatus mounted to the rotating shaft. Rotation of the toothed wheel mounted to the rotating shaft may be monitored using a reader. As with the system of an encoder and reader, the toothed wheel system must be particularly designed for the rotating shaft, and requires alignment of the reader with the toothed wheel.

Disclosed herein are apparatuses and systems for monitoring a rotating shaft using a shaft-mounted accelerometer. The apparatuses and systems may calculate a rotational speed of the rotating shaft and/or an angular position of the rotating shaft. The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described may be implemented as software modules or components. As used herein, a software module or component may include any type of computer instruction or computer executable code located within a memory device and/or transmitted as electronic signals over a system bus or wired or wireless network. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory computer and/or machine-readable medium having stored thereon instructions that may be used to program a computer (or other electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor executable instructions.

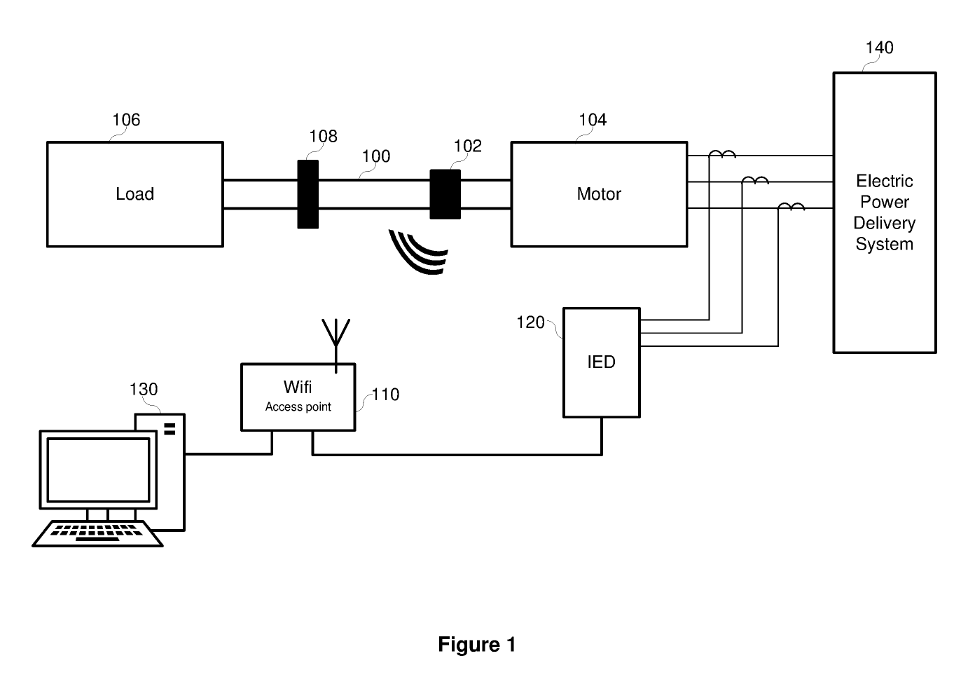

FIG. 1 illustrates a simplified block diagram of a system with a monitored rotating shaft and an apparatus for monitoring the rotating shaft. The system includes a motor 104 providing mechanical power to a load 106 using a rotating shaft 100. The shaft may include one or more couplers 108. The motor 104 may be configured to receive electric power from an electric power delivery system 140, and convert the electrical power to mechanical power delivered using the rotating shaft 100 to load 106. The motor 104 may be a three-phase motor, receiving three phases of electric power from the electric power delivery system 140. In other embodiments, the electric motor 104 may be a single-phase motor, a two-phase motor, or the like.

IED 120 is configured to monitor and protect the motor. IED 120 may receive measurements of the electric power delivered to the motor 104 by the electric power delivery system 140 using, for example, current transformers (CTs) to monitor electrical current to the motor 104, potential transformers (PTs) to monitor the voltage of the electrical power to the motor 104, and the like. The IED 120 may be configured to disconnect power to the electric motor 104 under certain conditions. For example, during startup, if the IED 120 detects that the motor is receiving electric power but is not turning the rotating shaft (a “locked rotor” condition), the IED 120 may be configured to disconnect electric power to the motor 104 by, for example, signaling a circuit breaker (not separately illustrated) to open. Many operating conditions of the electric motor 104 may be monitored using the current and/or voltage signals from the electric power supplied to the motor 104 including, for example locked rotor conditions, overcurrent, arc flash, thermal conditions, broken bar, efficiency, and the like.

IED 120 may include various inputs for accepting signals related to the operation of the electric motor 104. For example, IED 120 may be configured to directly monitor a temperature, and thus include an input for receiving a signal related to a temperature. A signal related to the temperature may be provided by a thermocouple in proximity with the equipment to be monitored and in electrical communication with the IED 120 to provide the signal thereto. The IED 120 may include an input for receiving a signal related to the rotational speed and/or angular position of the rotating shaft 100 as described above, such may be from a speed switch, encoder/reader, toothed wheel and reader, or the like.

In the illustrated embodiment, a signal corresponding with the rotation of the rotating shaft may be provided by a wireless access point 110 in wireless communication with a shaft-mounted sensor 102. The shaft-mounted sensor 102 may be configured to provide a signal wirelessly to the wireless access point 110 related to the rotational speed and/or angular position of the rotating shaft 100. As will be described in more detail below, the shaft-mounted sensor 102 may include an accelerometer, a power supply, and a wireless transmitter to wirelessly provide a signal related to an acceleration of the rotating shaft. The acceleration may be related to a radial acceleration of the rotating shaft, a tangential acceleration of the rotating shaft or the like. The acceleration may be related to an acceleration due to gravity. The acceleration may be related to a combination of a radial and/or tangential acceleration from the rotation of the rotating shaft and an acceleration due to gravity. The shaft-mounted sensor 102 may be configured to wirelessly transmit one or more signals related to the detected acceleration to the wireless access point 110.

The wireless access point 110 may be in communication with the IED 120 to provide the one or more signals from the shaft-mounted sensor 102 to the IED 120. The IED 120 may then calculate certain rotational components of the rotating shaft from the one or more signals from the shaft-mounted sensor. For example, the IED 120 may be configured to calculate a rotational speed of the rotating shaft 100 using a signal related to the acceleration from the shaft-mounted sensor 102 due to the rotation of the rotating shaft 100 and a distance from the center of the rotating shaft to the shaft-mounted sensor. In another embodiment, the IED 120 may be configured to calculate an angular position of the rotating shaft using a signal related to the acceleration due to gravity detected by the shaft-mounted sensor 102.

The wireless access point 110 may further be in communication with a monitoring system 130. The monitoring system 130 may be a local or remote computing device, an access controller, a programmable logic controller, a Supervisory Control and Data Acquisition (“SCADA”) system, or the like. The monitoring system 130 may similarly be configured to receive the signals originating from the shaft-mounted sensor 102 and calculating rotational components of the rotating shaft 100 from the signals. For example, the monitoring system 130 may be configured to calculate a rotational speed, angular position, or the like, of the rotating shaft 100 using the signals.

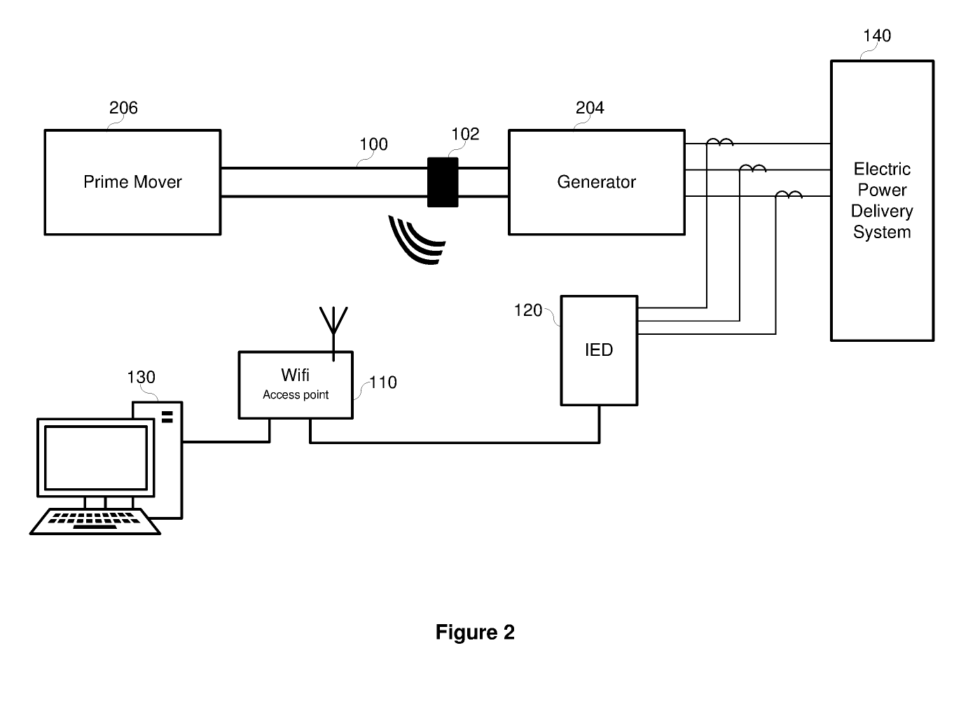

FIG. 2 illustrates a block diagram of another embodiment of a system for monitoring a rotating shaft. According to the embodiment illustrated in FIG. 2, the rotating shaft 100 comprises a shaft driving an electric power generator 204 by a prime mover 206. The electric power generator 204 is configured to generate electric power from the mechanical power provided thereto by the prime mover 206 via the rotating shaft 100 and supply such electric power to the electric power delivery system 140. The IED 120 may be, for example, a generator protection IED configured to monitor and protect the generator 204. The IED 120 may be configured to obtain electric power system signals from the electric power produced by the generator 204. IED 120 may be in communication with the electric power outputs using CTs, PTs, or the like.

IED 120 may be configured to separate the generator 204 from the electric power delivery system 140 upon detection of certain operating conditions of the generator 204 by, for example, opening a circuit breaker connecting the generator 204 to the electric power delivery system 140. IED 120 may further be configured to control the prime mover 206 in response to conditions detected from the output of the generator 204. For example, the prime mover 206 may be a diesel engine, and the IED may be configured to maintain a certain output of the generator by controlling the fuel provided to the diesel engine.

Although not separately described above, several operating conditions of rotating equipment may be monitored by IEDs. For example, generator protection IEDs may monitor and control for over/under speed protection, power output, frequency, stator or rotor faults, brush liftoff, and the like.

Although specifically described in conjunction with the monitoring of rotating shafts of generators and motors, embodiments described herein may be used to monitor the rotational speed and/or angle of any rotating shaft. In various embodiments, the rotating shaft may be a rotating shaft of a motor, a generator, a transmission shaft, a drive shaft, an axle, a crankshaft, or the like.

Furthermore, it should be noted that the wireless access point 110 illustrated in FIGS. 1 and 2 may be embodied in the IED 120 and/or the monitoring system 130. In one particular embodiment, the IED 130 may include the wireless access point 110, and be in wireless communication with the shaft-mounted sensor 102.

In several embodiments described herein, the shaft-mounted sensor 102 may be configured to wirelessly transmit signals according to an established protocol such as, for example, WiFi, Bluetooth, Zigbee, or the like. In such an embodiment, the IED 120 may include a wireless interface to wirelessly communicate with the shaft-mounted sensor 102. Furthermore, the IED 120 may include a standardized input that may receive a wireless interface for receiving the wireless communications from the shaft-mounted sensor 102. For example, the IED 120 may include a serial port or a USB port, and the wireless interface may include a Bluetooth-to-serial converter such as, for example, the SEL-2925 Bluetooth Serial Adapter available from Schweitzer Engineering Laboratories, Inc. of Pullman, Wash., USA. The wireless interface may receive the wireless transmissions from the shaft-mounted sensor 102 and provide such signals to the IED 120. Alternatively, the IED may include an integrated wireless interface for communication with the shaft-mounted sensor 102.

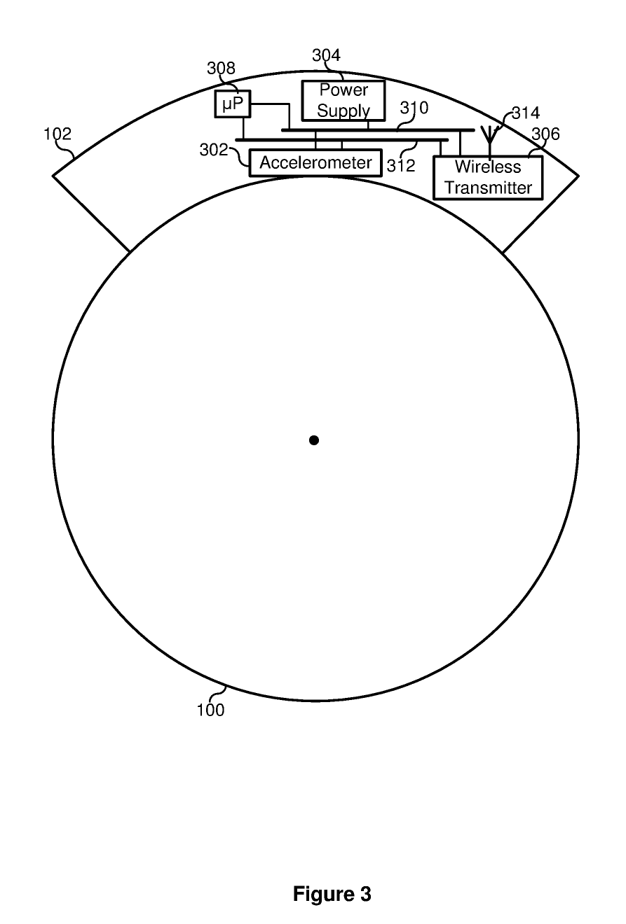

FIG. 3 illustrates a block diagram of a shaft-mounted sensor that may be used in the embodiments illustrated and described in conjunction with several embodiments herein, including those illustrated in FIGS. 1 and 2. Components of the shaft-mounted sensor 102 may be powered by a power supply 304 in electrical communication with a power bus 310. The power supply may be powered by, for example, a battery, a piezoelectric generator, a micro-electromechanical system (MEMS) generator, or the like. The shaft-mounted sensor 102 may include an accelerometer 302, a wireless transmitter 306, and a processor 308 each in communication with a data bus 312 and receive power from the power supply 304 using the power bus 310. The data bus may operate according to a standard such as, for example, the I2C standard. The processor 308 may be a microprocessor, field-programmable gate array (FPGA), controller, application specific integrated circuit (ASIC), or the like. The processor 308 may include a memory component for storing computer instructions to be executed by the processor 308. In certain embodiments, the shaft-mounted sensor may also include a memory component in communication with the bus 312 for storing computer instructions for execution by the processor. In certain embodiments, the memory component may be used to store information, and may be re-writeable.

The accelerometer 302 may be configured to detect an acceleration and provide a signal corresponding to the detected acceleration for use by the processor 308 and/or transmitted by the wireless transmitter 306. The processor 308 may be configured to control the accelerometer 302 and the wireless transmitter 306. The wireless transmitter 306 may be configured to transmit a signal related to the output of the accelerometer 302, communications from the processor 308, and the like. The wireless transmitter 306 may include or be in communication with an antenna device 314 for wireless transmission of the signal. The wireless transmitter 306, as has been described above, may be configured to transmit a signal according to a predetermined protocol such as, for example, Wi-Fi, Bluetooth, Zigbee, or the like.

The accelerometer 302 may operate according to piezoelectric, piezoresistive, capacitive principles or the like, including combinations thereof. The accelerometer 302 may be a MEMS accelerometer. The accelerometer 302 may be configured to measure accelerations of up to around ±3000 g.

The shaft-mounted sensor 102 may be mounted to the shaft 100 using one or more of various attachment means. In one embodiment, the shaft-mounted sensor 102 may be fixed to the shaft 100 using an adhesive between the shaft 100 and the shaft-mounted sensor 102. In another embodiment, the shaft-mounted sensor 102 may be fixed to the shaft 100 using a mechanical clamping mechanism. In other embodiments, the shaft-mounted sensor 102 may be fixed to the shaft 100 using more than one mounting techniques such as an adhesive and a mechanical clamping mechanism.

The shaft-mounted sensor as illustrated and described herein may be used to provide a signal related to the acceleration measured by the accelerometer 302. Such a signal may be used by an IED or a monitoring system to calculate a rotational speed and/or angular position of the rotating shaft as described herein. In other embodiments, the processor 308 may use the signal from the accelerometer to calculate a rotational speed and/or angular position of the rotating shaft as described herein. In such embodiments, the processor may be pre-set or programmable with the radius of the rotating shaft. The processor may be configured to transmit the calculated rotational speed and/or angular position using the wireless transmitter.

In still other embodiments, the processor may be configured to compare the calculated rotational speed with a predetermined threshold. The processor may be pre-set or programmable with the predetermined threshold. In such embodiments, the processor may be configured to cause the wireless transmitter to transmit a message when the predetermined threshold is crossed. In one particular embodiment, the shaft-mounted sensor may be configured to transmit a speed sensor message once the calculated rotational speed reaches a predetermined threshold. The IED or other monitoring system may be configured to interrupt operation of the rotating machinery if the speed switch message is not received within a predetermined time from starting the rotating machinery. In other embodiments, the threshold may be set above a nominal operating condition of the rotating machinery. The processor may be configured to cause the wireless transmitter to transmit a message indicating that the rotational speed of the shaft has exceeded the threshold. The IED or other monitoring system may use such message in protection and monitoring of the rotating machinery.

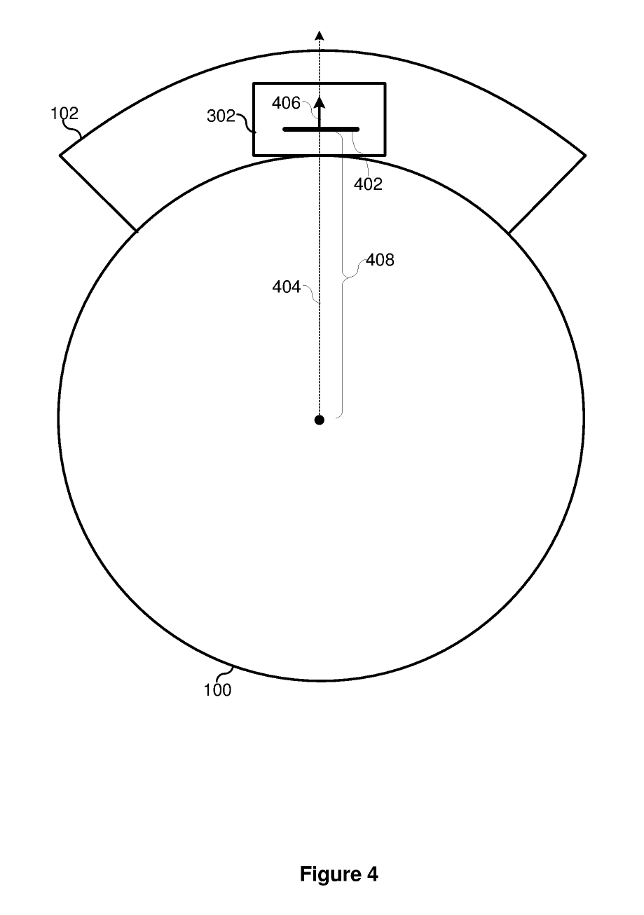

FIG. 4 illustrates another block diagram of the shaft-mounted apparatus 102 fixed to the rotating shaft 100. The accelerometer 302 includes a sensing component 402 fixed a known distance 408 from the center of the shaft 100. Furthermore, the sensing component 402 of the accelerometer 302 includes an axis 406 of detection, and determines an acceleration along the axis 406 of detection. In one embodiment, the accelerometer 302 is fixed to the rotating shaft 100 such that the axis of detection 406 is collinear with a radius 404 of the rotating shaft.

According to the embodiment illustrated in FIG. 4, the acceleration measured by the accelerometer 302 is a radial acceleration, and the rotational speed of the rotating shaft 100 may be expressed as a function of the measured radial acceleration and the distance 408 from the center of the rotating shaft 100 to the sensing component 402. Equations 1-3 may be used to calculate the rotational speed.

$$\begin{matrix}RPM = \frac{60}{2 π} \sqrt{\frac{a}{r}} & Eq . 1 \\ rev \text{/} s = \frac{1}{2 π} \sqrt{\frac{a}{r}} & Eq . 2 \\ rad \text{/} s = \sqrt{\frac{a}{r}} & Eq . 3\end{matrix}$$

where:
RPM is rotations per minute;
a is the acceleration measured in meters-per-second-per-second (m/s²);
r is the distance from the center of the rotating shaft to the sensing component in meters;
rev/s is revolutions per second; and
rad/s is radians per second.

The embodiment illustrated in conjunction with FIG. 4, and Equations 1-3 may be used where the acceleration measured by the accelerometer is due only to the rotation of the rotating shaft. For example, where the shaft is mounted vertically, the measured acceleration is likely only due to the rotation of the rotating shaft. However, where the shaft is not mounted vertically, the measured acceleration may include a component of the acceleration due to the rotation of the rotating shaft and a component due to the acceleration of gravity.

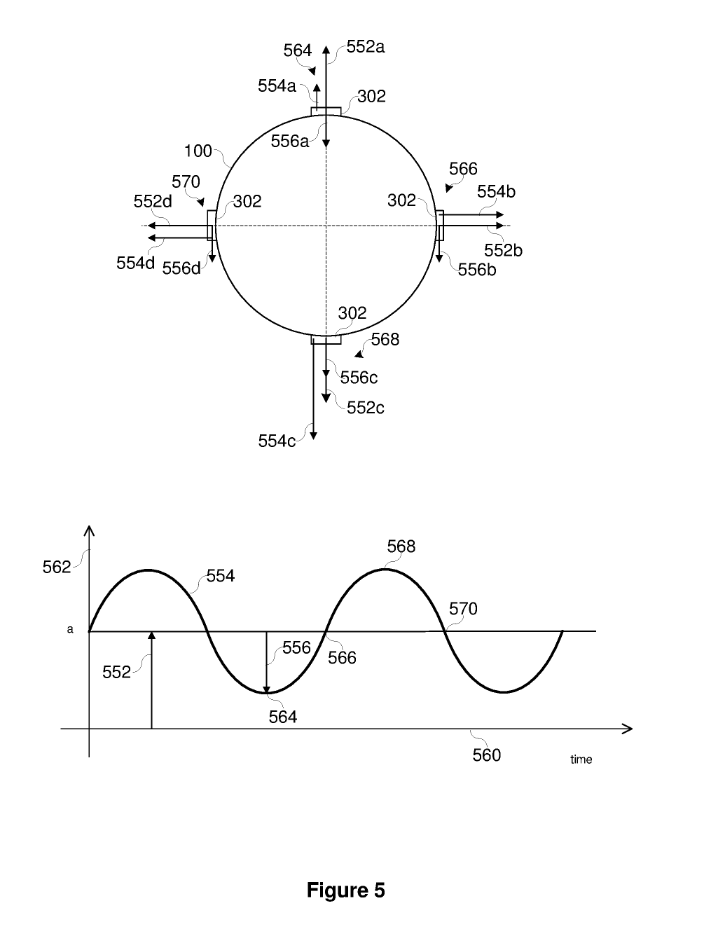

FIG. 5 illustrates a cross-sectional view of a rotating shaft 100 and the accelerometer 302 at various positions during a rotation of rotating shaft configured in a non-vertical orientation, as well as a plot of the measured acceleration over time during two periods of rotation of the rotating shaft 100. In a first position 564 with the accelerometer 302 on a top of the rotating shaft 100, the accelerometer 302 will output a measured acceleration 554a which is a sum of the radial component of acceleration due to gravity 556a and a radial acceleration 552a due to the rotation of the rotating shaft 100. Subsequently at position 566, the accelerometer 302 will output a measured acceleration 554b which is a sum of the radial component of the acceleration due to gravity 556b and a radial acceleration 552b due to the rotation of the rotating shaft 100. Similarly, at position 568, the accelerometer 302 will output a measured acceleration 554c which is a sum of the radial component of the acceleration due to gravity 556c and a radial acceleration 552c due to the rotation of the rotating shaft 100. Finally, as illustrated at position 570, the accelerometer 102 will output a measured acceleration 554d which is a sum of the radial component of acceleration due to gravity 556d and a radial acceleration 552d due to the rotation of the rotating shaft 100. It should be noted that the acceleration due to gravity in the radial direction at positions 566 and 570 is zero. Thus, at positions 566 and 570, the measured acceleration is the acceleration due to the rotation of the rotating shaft. At positions 564 and 568, however, the measured acceleration is the sum of the acceleration due to gravity and the acceleration due to the rotation of the rotating shaft.

FIG. 5 further illustrates a plot of acceleration 562 over time 560 at the various positions 564, 566, 568, and 570. The measured acceleration 554 at position 564 is the sum of the acceleration due to gravity 556 and the acceleration 552 due to the rotation of the rotating shaft. At positions 566 and 570, the measured acceleration 554 is due only to the acceleration 552 of the rotating shaft. At position 568, the measured acceleration 554 is due to the sum of the acceleration due to gravity 556 and the acceleration 552 due to the rotation of the rotating shaft.

The measured acceleration as illustrated in FIG. 5 may be used to calculate the rotational speed of the rotating shaft. However, because each instantaneous measured acceleration value includes components due to the acceleration of the rotating shaft and acceleration due to gravity, the measured acceleration 554 cannot be used as the acceleration in Equations 1-3 to calculate the rotational speed. It should be noted that the measured acceleration 554 is a periodic waveform with an offset. The offset is the acceleration due to the rotation of the rotating shaft. In some embodiments, an average of the measured acceleration over a predetermined time may be used as the acceleration in Equations 1-3 to determine the rotational speed of the rotating shaft. In several embodiments herein, the average of the measured acceleration may be determined using a low-pass filter on the measured acceleration.

In some embodiments the rotational speed of the rotating shaft may be calculated using a period of the periodic waveform from the measured acceleration 554. A time between positive peaks (or negative peaks) may be measured to determine a period of the periodic waveform. The inverse of the period is a frequency of the periodic waveform, and hence a frequency of the rotating shaft in revolutions per second. Such frequency can be used to determine the rotational speed in the desired units such as, for example, revolutions per second, revolutions per minute, radians per second, or the like.

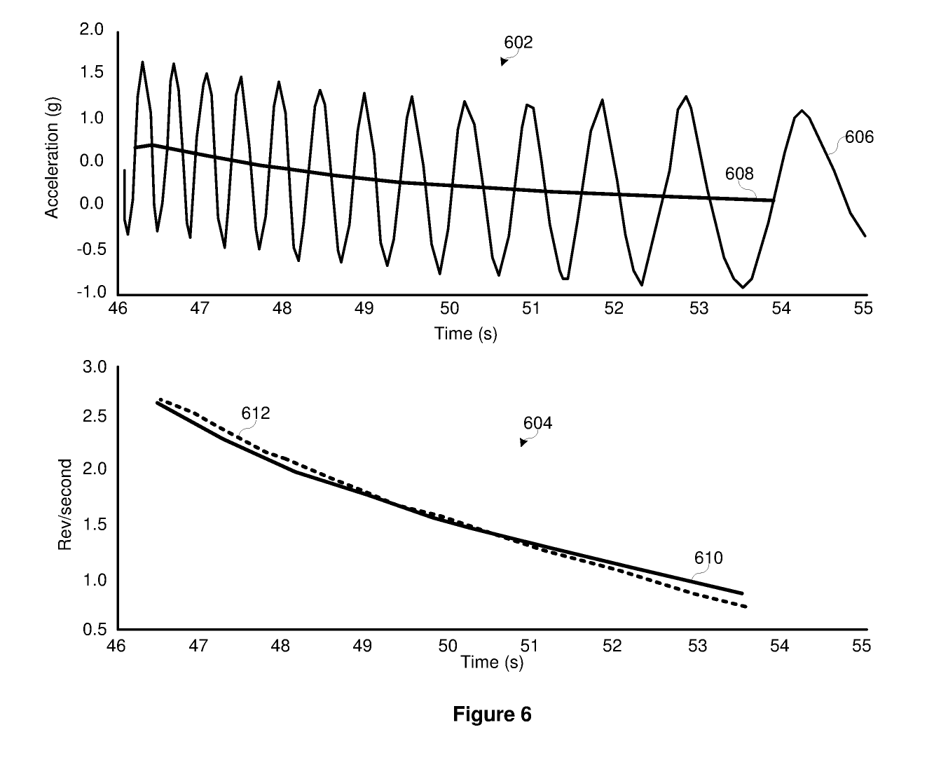

FIG. 6 illustrates plots over time of the measured acceleration and the calculated rotational speed of a rotating shaft according to various embodiments described herein. Plot 602 illustrates the measured acceleration 606 as the rotating shaft slows as well as a calculated average 608 of the measured acceleration as the rotating shaft slows. Plot 604 illustrates the calculated rotational speed of the rotating shaft in revolutions per second. Trace 612 illustrates the rotational speed calculated using a determined period from peak values of the measured acceleration 554 as described above. Trace 610 uses the average of the measured acceleration 606 as the acceleration in Equation 2.

In embodiments where the rotating shaft is configured with its axis in the horizontal, the acceleration due to gravity will be −1 g, and the amplitude of the waveform of the measured acceleration 554 will be 1 g. For example, the amplitude of the measured acceleration 606 illustrated in FIG. 6 is close to 1 g, so the rotating shaft must be configured with its axis near horizontal. In embodiments where the rotating shaft is configured with its axis in orientations approaching vertical, the acceleration due to gravity in the radial direction with respect to the rotating shaft will approach zero, and the amplitude of the waveform of the measured acceleration 554 will approach zero.

In embodiments where the measured acceleration includes a component due to the acceleration of gravity such as where the rotating shaft is in a non-vertical orientation, an angular position of the rotating shaft may be calculated. That is, where the shaft is configured with its axis not in the vertical, the measured acceleration will be a periodic waveform with an offset related to the rotational speed of the rotating shaft, an amplitude related to the orientation of the shaft from horizontal to vertical, and a periodicity that can be used to calculate an angular position of the rotating shaft. For example, a difference between the measured acceleration and the average acceleration can be normalized by the amplitude of the waveform, and used to calculate the angular position in radians or degrees. Such calculation may be expressed as Equation 4:

$$\text{∝} \text{=} {sin}^{- 1} ( \frac{{a}_{m} - {a}_{v}}{A} ) \qquad Eq . 4$$

where:
α is an angular position of the rotating shaft;
aₘ is the measured acceleration;
aᵥ is the average acceleration; and
A is the amplitude of the waveform (1 g for horizontally-mounted rotating shafts).

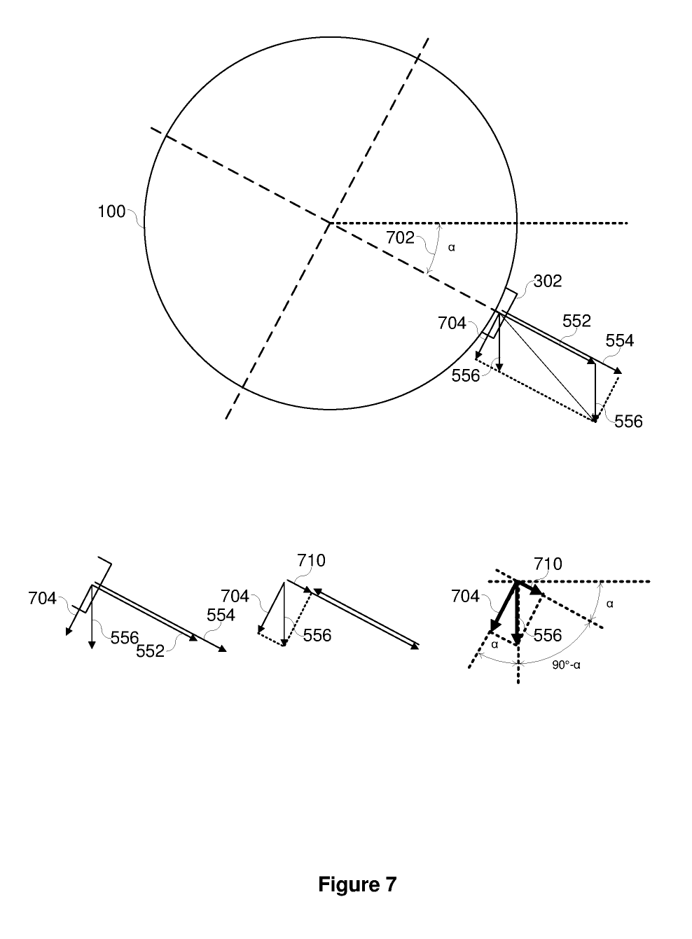

FIG. 7 illustrates a cross-sectional view of a rotating shaft 100 and accelerometer 302 according to several embodiments herein. The accelerometer 302 according to the illustrated embodiments may include two axes of sensing. Such accelerometer 302 may be a two-axis or three-axis accelerometer. The accelerometer 302 may be fixed to the rotating shaft 100 such that one axis of sensing is collinear with a radius of the rotating shaft 100, and another axis of sensing in a direction tangential to the rotating shaft 100. Accelerometer 302 may be configured to measure a tangential acceleration 704 and a radial acceleration 554. A rotational speed of the rotating shaft may be calculated using the measured radial acceleration 554 according to the several embodiments described above.

The angular position of the rotating shaft 100 may be calculated during operation and at standstill using the measured tangential acceleration 704 and measured radial acceleration 554. The angular position a of the rotating shaft can be calculated using the measured tangential acceleration 704 and a difference 710 between the measured radial acceleration 554 and the radial acceleration due to the rotation of the shaft, which may be approximated using an average radial acceleration. As discussed above, any of several methods may be used to calculate the average radial acceleration such as, for example, use of a low-pass filter. The angular position a of the rotating shaft may be calculated using Equation 5:

$$\text{∝} \text{=} {tan}^{- 1} ( \frac{M x}{M t} ) \qquad Eq . 5$$

where:
α is an angular position of the rotating shaft;
Mx is Mr−a;
Mt is the measured tangential acceleration;
Mr is the measured radial acceleration; and
a is the acceleration due to shaft rotation, which may be an average of Mr.

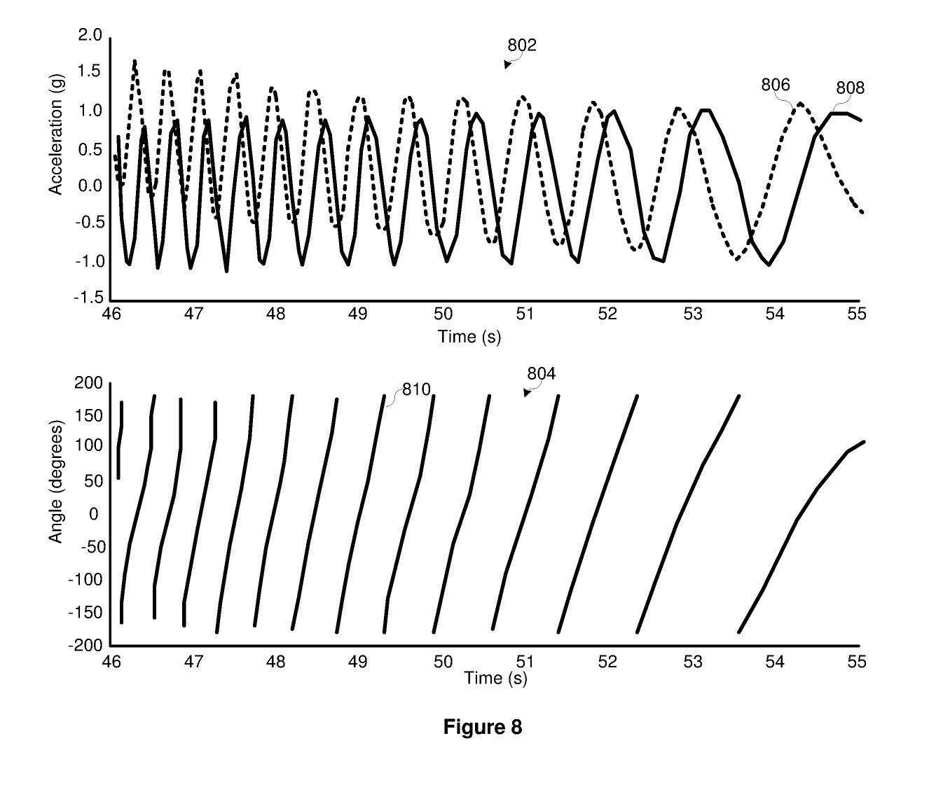

FIG. 8 illustrates plots of the measured radial and tangential acceleration of a rotating shaft and the calculated angular position in degrees of the rotating shaft. Plot 802 shows trace 806 representing the measured radial acceleration, where trace 808 shows the measured tangential acceleration. FIG. 8 represents the acceleration and angle of a rotating shaft as the rotating shaft slows. Using the embodiments described herein, and in particular Equation 5, the angular position of the rotating shaft is calculated and shown in plot 804 as trace 810 in degrees.

In certain embodiments the angular position of the rotating shaft may be used to calculate the rotational speed of the rotating shaft. The angular position of the rotating shaft may be calculated according to any of the embodiments described herein. To calculate the rotational speed of the rotating shaft, the difference in angular position with respect to time may be calculated using, for example, Equation 6.

$$S = \frac{d ∝}{d t} \qquad Eq . 6$$

where:
α is an angular position of the rotating shaft; and
S is the rotational speed of the rotating shaft.

In one embodiment, the processor of the shaft-mounted sensor is configured to calculate the rotational speed of the shaft using the angular position of the rotating shaft. In other embodiments an IED may be configured to calculate the rotational speed of the shaft using the angular position of the rotating shaft.

Rotating shafts of rotating machinery in industry and utility are configured in a wide array of diameters and nominal rotational speeds. The radial acceleration to be measured by a shaft mounted accelerometer according to the various embodiments herein is a function of the rotational speed of the rotating shaft and the distance from the center of the rotating shaft to the acceleration sensing component of the shaft-mounted accelerometer. Thus, accelerometers according to the various embodiments herein may be used to measure a wide range of acceleration. Table 1 shows several different radial acceleration values that may be measured by accelerometers on shafts of different radii and at different rotational speeds:

TABLE 1

| | | | Shaft radius [mm] | | | | | | | |
|---|---|---|---|---|---|---|---|---|---|---|
| | | | 5 mm | | | | | | 105 mm | |
| Rotational Speed | | | (~⅓ HP) | | 25 mm | | 40 mm | | (~100 HP) | |
| RPM | rev/sec | rads/sec | m/s² | g | m/s² | g | m/s² | g | m/s² | g |
| 60 | 1 | 6.28 | 0.20 | 0.0 | 1 | 0.1 | 2 | 0.2 | 4 | 0.4 |
| 750 | 12.5 | 78.54 | 31 | 3.1 | 154 | 15.7 | 247 | 25.2 | 648 | 66.1 |
| 900 | 15 | 94.25 | 44 | 4.5 | 222 | 22.7 | 355 | 36.3 | 933 | 95.2 |
| 1500 | 25 | 157.08 | 123 | 12.6 | 617 | 62.9 | 987 | 100.7 | 2591 | 264.4 |
| 1800 | 30 | 188.50 | 178 | 18.1 | 888 | 90.6 | 1421 | 145.0 | 3731 | 380.7 |
| 3000 | 50 | 314.16 | 493 | 50.4 | 2467 | 251.8 | 3948 | 402.8 | 10363 | 1057.5 |
| 3600 | 60 | 376.99 | 711 | 72.5 | 3553 | 362.6 | 5685 | 580.1 | 14923 | 1522.7 |

The useful range of accelerometers used to measure radial acceleration on a rotating shaft may be extended according to several embodiments herein. An accelerometer of a shaft-mounted sensor according to embodiments such as is illustrated in FIG. 4 with an axis collinear with a radius of the rotating shaft will output a signal that can be used to calculate the detected radial acceleration. Accelerometers with a predetermined rating would be useful on shafts with a radius and rotational speed that would yield an acceleration within the predetermined rating. For example, an accelerometer rated at ±100 g would be useful for certain shafts at certain rotational speeds, but would not be useful for measuring a radial acceleration on larger shafts, or at higher speeds (e.g. a shaft with a 40 mm radius above 1500 RPM). However, according to certain embodiments herein, the useful range of an accelerometer may be extended by orienting the accelerometer such that its axis of measurement is at a predetermined angle from the radius of the rotating shaft.

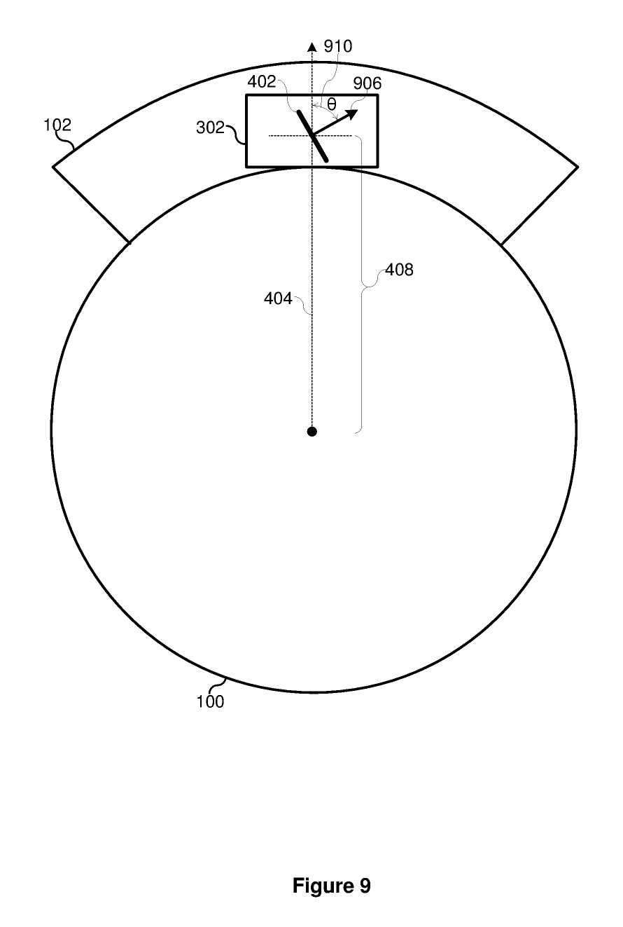

FIG. 9 illustrates a cross section of a rotating shaft 100 with a shaft-mounted sensor 102 that includes accelerometer 302 with a sensor 402. The sensor 402 includes an axis 906 of sensing acceleration that is oriented at a predetermined angle θ 910 from the radius 404 of the rotating shaft 100. The measured acceleration of the accelerometer 302 is then less than the actual radial acceleration by a factor that is a function of the predetermined angle 910. That is, the useful range of the accelerometer is extended by a factor that is a function of the predetermined angle 910. For example, an accelerometer oriented with its axis 906 at a predetermined angle 910 of 60° would output an acceleration of half of the radial acceleration. Such would result in an extension factor of 2, in that the accelerometer would be useful to measure accelerations up to twice its rated range. However, the output would be the inverse of the range extension factor. Table 2 illustrates a number of predetermined angles and range extension factors for accelerometers oriented with the predetermined angles.

TABLE 2

| Angle | Range extension factor |
|---|---|
| 0.0 | 1 |
| 45.0 | 1.41 |
| 48.2 | 1.5 |
| 60.0 | 2 |
| 70.5 | 3 |
| 78.4 | 5 |
| 84.3 | 10 |

In certain embodiments, the accelerometer may be oriented within the shaft-mounted sensor such that an axis of the accelerometer is oriented at a known angle from collinear with the radius of the rotating shaft. The shaft-mounted sensor may be configured to use the known angle in its calculation of the acceleration by multiplying the acceleration from the accelerometer by the range extension factor to yield the measured acceleration.

While specific embodiments and applications of the disclosure have been illustrated and described, it is to be understood that the disclosure is not limited to the precise configurations and components disclosed herein. For example, the systems and methods described herein may be applied to an industrial electric power delivery system or an electric power delivery system implemented in a boat or oil platform that may not include long-distance transmission of high-voltage power. Moreover, principles described herein may also be utilized for protecting an electric system from over-frequency conditions, wherein power generation would be shed rather than load to reduce effects on the system. Accordingly, many changes may be made to the details of the above-described embodiments without departing from the underlying principles of this disclosure. The scope of the present invention should, therefore, be determined only by the following claims.

What is claimed is:

1. A system for calculating a rotational speed and angle of a rotating shaft, comprising:
an accelerometer fixed to the rotating shaft, configured to output a radial acceleration signal representative of an acceleration due to gravity and an acceleration due to a rotation of the rotating shaft;
a wireless transmitter in communication with the accelerometer, configured to transmit a signal representative of the radial acceleration signal;
a power supply in electrical communication with the accelerometer and the wireless transmitter, configured to supply electrical power to the accelerometer and the wireless transmitter;
an intelligent electronic device (IED) in wireless communication with the wireless transmitter, the IED comprising:
a rotational speed module configured to calculate a rotational speed of the rotating shaft from the radial acceleration signal; and
an angular position module configured to calculate an angular position of the rotating shaft from the radial acceleration signal.

2. A system for monitoring a rotating shaft, comprising:
an accelerometer fixed to the rotating shaft, configured to output a signal representative of an acceleration at a point on the rotating shaft;
a wireless transmitter in communication with the accelerometer, configured to transmit a signal representative of the output signal of the accelerometer;
a power supply in electrical communication with the accelerometer and the wireless transmitter, configured to supply electrical power to the accelerometer and the wireless transmitter;
an intelligent electronic device (IED) in wireless communication with the wireless transmitter, the IED comprising:
a rotational shaft module configured to calculate a rotational component of the rotating shaft based on the transmitted signal representative of the output signal of the accelerometer.

3. The system of claim 2, further comprising a microcontroller in communication with the accelerometer, wireless transmitter, and power supply for receiving the output signal from the accelerometer, and controlling the wireless transmitter.

5. The system of claim 2, wherein the rotational component of the rotating shaft comprises a rotational speed of the rotating shaft.

6. The system of claim 5, wherein the rotational shaft module is configured to calculate the rotational speed of the rotational shaft using the output signal of the accelerometer and a distance between a center of the rotating shaft and the accelerometer.

7. The system of claim 5, wherein the output of the accelerometer is representative of an acceleration from a rotation of the rotating shaft.

8. The system of claim 2, wherein the accelerometer comprises an axis of measurement, and the accelerometer is fixed to the rotating shaft with the axis of measurement collinear with a radius of the rotating shaft.

9. The system of claim 2, wherein the accelerometer comprises an axis of measurement, and the accelerometer is fixed to the rotating shaft with a predetermined angle between the axis of measurement and a radius of the rotating shaft, and the rotational shaft module is configured to calculate the rotational component of the rotating shaft based on the transmitted signal and the predetermined angle.

10. The system of claim 2, wherein the output of the accelerometer is representative of an acceleration from gravity and an acceleration from a rotation of the rotating shaft.

11. The system of claim 10, wherein the rotating shaft comprises a non-vertical orientation.

12. The system of claim 11, wherein the IED further comprises a shaft angle module configured to calculate an angular position of the rotating shaft from the output of the accelerometer representative of an acceleration from gravity.

13. The system of claim 10, wherein the rotational component of the rotating shaft comprises a rotational speed of the rotating shaft.

14. The system of claim 2, wherein the accelerometer comprises two axes and the signal representative of the acceleration comprises a signal representative of a radial acceleration and a tangential acceleration.

15. The system of claim 14, wherein the rotational component of the rotating shaft comprises an angular position of the rotating shaft, and the rotational shaft module is configured to calculate the angular position of the rotating shaft using the radial acceleration and the tangential acceleration.

16. The system of claim 2, wherein the rotational component comprises an angular position of the rotating shaft.

17. The system of claim 2, wherein the rotational shaft module is further configured to calculate a rotational speed of the rotating shaft using the angular position of the rotating shaft.

18. An apparatus for monitoring a rotating shaft, comprising:
an accelerometer fixed to the rotating shaft, configured to output a signal representative of an acceleration at a point on the rotating shaft;
a power supply configured to supply electrical power; and,
a processor in communication with the accelerometer and the power supply configured to
receive the signal representative of the acceleration;
calculate a rotational component of the rotating shaft using the signal representative of the acceleration from the accelerometer

19. The apparatus of claim 18, wherein the signal representative of an acceleration comprises a radial acceleration from a rotation of the rotating shaft.

20. The apparatus of claim 19, wherein the rotational component comprises a rotational speed of the rotating shaft.

21. The apparatus of claim 18, wherein the signal representative of an acceleration comprises a radial acceleration from a rotation of the rotating shaft and an acceleration from gravity.

22. The apparatus of claim 21, wherein the rotational component comprises an angular position of the rotating shaft.

23. The apparatus of claim 18, wherein the accelerometer comprises an axis of measurement, and the accelerometer is fixed to the rotating shaft with the axis of measurement collinear with a radius of the rotating shaft.

24. The apparatus of claim 18, wherein the accelerometer comprises an axis of measurement, and the accelerometer is fixed to the rotating shaft with a predetermined angle between the axis of measurement and a radius of the rotating shaft, and the processor is configured to calculate the rotational component of the rotating shaft using the predetermined angle.

25. The apparatus of claim 18, wherein the accelerometer comprises two axes and the signal representative of the acceleration comprises a signal representative of a radial acceleration and a tangential acceleration.

26. The apparatus of claim 25, wherein the rotational component comprises an angular position of the rotating shaft and the processor is configured to calculate the angular position using the radial acceleration and the tangential acceleration.

27. The apparatus of claim 18, wherein the rotational component comprises an angular position of the rotating shaft.

28. The apparatus of claim 18, wherein the processor is further configured to calculate a rotational speed of the rotating shaft using the angular position of the rotating shaft.

29. The apparatus of claim 18, further comprising a wireless transmitter in communication with the power supply and the processor configured to wirelessly transmit to a consuming device.
